(19) United States
(12) Patent Application Publication
(10) Pub. No.: US 2005/0062395 A1
(43) Pub. Date: Mar. 24, 2005

(54) AC-driven electroluminescent element having light emission layer in which particles each containing fluorescent portion are densely arranged

(75) Inventors: Kenji Takahashi, Kanagawa-ken (JP); Hiroshi Fujimoto, Minamiashigara-shi (JP); Tomotake Ikada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/942,986

(22) Filed: Sep. 17, 2004

(30) Foreign Application Priority Data
Sep. 19, 2003 (JP) 328355/2003

(51) Int. Cl. H01J 63/04

(52) U.S. Cl. 313/467; 313/487

(57) ABSTRACT

An AC-driven electroluminescent element includes a pair of electrodes and a light emission layer being located between the pair of electrodes and containing particles and a filler with which gaps between the particles are filled. The particles are densely arranged in the light emission layer in such a manner that the particles are fused with each other or in mechanical or electrical contact with each other, and the ratio of the volume occupied by the particles to the volume occupied by the filler in the light emission layer is 1.0 or greater. Each particle has a portion made of a fluorescent material. When the outermost surfaces of all of the particles are not made of a dielectric material, at least one insulation layer is arranged on at least one side of the light emission layer.

### BACKGROUND OF THE INVENTION

1. Field of the Invention

The present invention relates to an alternate-current-driven (AC-driven) electroluminescent element which includes a light emission layer containing fluorescent particles and having a structure of a dispersion type, and the present invention also relates to a method for producing the above AC-driven electroluminescent element.

2. Description of the Related Art

The following documents (1) to (4) disclose information related to the present invention.

(1) International Patent Publication No. WO/02/080626

(2) Japanese Unexamined Patent Publication No. 2000-195674

(3) Inoguchi, Toshio, “Electroluminescent Display,” first edition, published in Japanese by Sangyo Tosho on Jul. 25, 1991

(4) T. Honda et al., “Cathodoluminescence spectra of GaN powders deposited on glass substrate,” Journal of Luminescence, Vols. 102-103 (2003) pp. 173-175

Currently, electroluminescent elements are expected to be used as, for example, planar light sources which emit light by themselves, or new display elements which do not require separate light sources. The conventional electroluminescent elements include two types, the dispersion type and the thin-film type. In addition, although direct-current-driven (DC-driven) electroluminescent elements are also proposed, the AC-driven electroluminescent elements are the mainstreams of the current research and development since the AC-driven electroluminescent elements are more practical than the DC-driven electroluminescent elements. Hereinbelow, the basic structures, the light emission mechanisms, and the characteristic features of the conventional electroluminescent elements of each of the dispersion type and the thin-film type, which are disclosed, for example, in the aforementioned document (3), are briefly explained.

Typically, the dispersion type electroluminescent elements have a structure as illustrated in FIG. 7. In the structure of FIG. 7, a transparent electrode 72 realized by a transparent conductive film is formed on a transparent substrate 70, which is realized by a sheet made of glass, polyethylene terephthalate (PET), or the like. The transparent electrode 72 can be formed by application of a material for the transparent conductive film. A light emission layer 74, an insulation layer 76, and a metal layer 78 are formed in this order on the transparent electrode 72. In the light emission layer 74, fluorescent particles 74a are discretely dispersed in a binder 74b, which is a dielectric material. In some cases, an additional layer such as a surface protection layer is provided. When an AC voltage is applied between the transparent electrode 72 and the metal layer 78, electroluminescence occurs in the fluorescent particles 74a in the binder 74b, and electroluminescent light is outputted through the transparent electrode 72 and the transparent substrate 70. Although the insulation layer 76 is provided for blocking current paths and applying a stable, strong electric field electric field to the fluorescent particles 74a, the insulation layer 76 is unnecessary in the case where complete separation between the individual fluorescent particles 74a is realized, and the current paths in the light emission layer 74 are blocked. In most cases, the fluorescent particles 74a are realized by ZnS particles which are doped with an activator containing copper, and have a diameter of about 5 to 30 micrometers. A typical example of the material for the fluorescent particles 74a is ZnS:Cu, Cl, which emits blue-green light. Alternatively, according to the desired colors of the electroluminescent light, ZnS:Cu, Al, or ZnS:Cu, Cl, Mn, and the like are used, where ZnS:Cu, Al emits green light, and ZnS:Cu, Cl, Mn emits orange light. The structure illustrated in FIG. 7 can be applied to color display devices and the like by multiply arranging in the thickness direction a plurality of electroluminescent elements using different kinds of fluorescent particles corresponding to a plurality of colors and each having the structure illustrated in FIG. 7, and making all of the electrodes located in the paths of electroluminescent light transparent.

Since the elements added as the activators behave as donors and acceptors, the AC-driven, dispersion type electroluminescent elements emit light when recombination occurs. For example, in the case of ZnS:Cu, Cl, Cl behaves as a donor, and Cu behaves as an acceptor. In this case, it is considered that the light emission locally occurs at portions at which needle crystals of Cu₂S are formed by precipitation along lattice defects in each ZnS particle, instead of uniformly occurring in the entire body of each fluorescent particle.

Typically, the thin-film type electroluminescent elements have a structure as illustrated in FIG. 8. In the structure of FIG. 8, as in the dispersion type electroluminescent elements, a transparent electrode 82 is formed on a transparent substrate 80, which is made of glass or the like. A first insulation layer 84a, a light emission layer 86, a second insulation layer 84b, and a metal layer 88 are formed in this order on the transparent electrode 82. The light emission layer 86 is a thin film of a fluorescent material formed by vacuum evaporation, sputtering, or the like. In some cases, an additional layer such as a surface protection layer or a buffer layer between the light emission layer and an insulation layer is provided. In most cases, each layer other than the light emission layer 86 is also formed by a technique for forming a thin film, such as vacuum evaporation. Therefore, although the structure of FIG. 8 is illustrated with an almost identical thickness to the element of FIG. 7 for simplification of the illustration, actually the thicknesses of the thin-film type electroluminescent elements are as small as about 1/100 of the thicknesses of the dispersion type electroluminescent elements. When an AC voltage is applied between the transparent electrode 82 and the metal layer 88, electroluminescence occurs in the light emission layer 86, and electroluminescent light is outputted through the transparent electrode 82 and the transparent substrate 80. A typical material for the light emission layer 86 is ZnS:Mn, in which a base material ZnS is doped with Mn as luminescent centers. The light emission layer 86 made of ZnS:Mn emits orange light. The thin-film type electroluminescent elements can be applied to color display devices and the like by adopting the structures called “dual pattern system” or “triple pattern system,” or multiply arranging in the thickness direction a plurality of elements corresponding to a plurality of colors and each having the structure illustrated in FIG. 8. In the dual pattern system or the triple pattern system, a plurality of light emission portions corresponding to a plurality of colors are two-dimensionally arranged. Further, unlike the dispersion type electroluminescent elements, at least one of the first insulation layer 84a and the second insulation layer 84b is indispensable for blocking current paths.

Although light emission in the dispersion type electroluminescent elements is caused by the donor-acceptor recombination, light emission in the thin-film type electroluminescent elements is caused by collisional excitation of luminescent centers by hot electrons traveling in the base material, where the hot electrons are electrons which are injected into the light emission layer 86 from traps in the light emission layer 86, and/or the interfaces between the light emission layer 86 and the first and second insulation layers 84a and 84b, and/or other portions, and accelerated by a strong electric field, during application of the AC voltage.

The advantages and disadvantages of the dispersion type electroluminescent elements and the thin-film type electroluminescent elements are as follows.

The manufacturing processes of the dispersion type electroluminescent elements are simple. Therefore, the dispersion type electroluminescent elements have various advantages. For example, the manufacturing cost of the dispersion type electroluminescent elements is low, the dispersion type electroluminescent elements can be easily upsized, and flexible, dispersion type electroluminescent elements can be manufactured. However, the intensities of electroluminescent light emitted from the dispersion type electroluminescent elements are lower than the intensities of electroluminescent light emitted from the thin-film type electroluminescent elements, the variety of colors of the light emitted from the dispersion type electroluminescent elements is small, and the dispersion type electroluminescent elements are not suitable for use in high-definition display devices and the like since the diameters of the dispersed fluorescent particles are large.

On the other hand, the thin-film type electroluminescent elements have various advantages. For example, the intensities of electroluminescent light emitted from the thin-film type electroluminescent elements are higher than the intensities of electroluminescent light emitted from the dispersion type electroluminescent elements, the thin-film type electroluminescent elements can show a great variety of colors since the variety of luminescent centers, which determine the colors, is great, and the thin-film type electroluminescent elements can be used for high-definition display. However, The manufacturing processes of the thin-film type electroluminescent elements are complicated, and therefore the manufacturing cost is high. In addition, since most portions of emitted light are totally reflected at the interface between the light emission layer and each insulation layer, the output efficiency of the light is very low (about 5 to 10%).

Further, another AC-driven electroluminescent element having a dispersion type structure similar to the structure of FIG. 7 has been proposed, for example, in the aforementioned document (1). In this AC-driven electroluminescent element, the fluorescent particles discretely dispersed in a light emission layer are made of a fluorescent material which is used in the light emission layers in the conventional thin-film type electroluminescent elements. It is considered that in this AC-driven electroluminescent element, electrons are injected into the fluorescent particles from the interfaces between the fluorescent particles and the dielectric material around the fluorescent particles, and/or traps in the fluorescent particles, and/or other portions, and accelerated so that the injected electrons become hot electrons, which cause collisional excitation of luminescent centers in the fluorescent particles. That is, it is considered that a light emission mechanism similar to those in the conventional thin-film type electroluminescent elements is realized in the proposed AC-driven electroluminescent element.

Hereinbelow, the aforementioned dispersion type electroluminescent elements are considered again. In the light emission layers in most of the conventional dispersion type electroluminescent elements, completely or almost completely discrete dispersion of the fluorescent particles is realized in the binder in order to block current paths. In only some limited cases, it is conjectured that a portion of fluorescent particles in the light emission layer are in contact with each other due to deposition or the like.

For example, the aforementioned document (4) discloses an electroluminescent element in which a light-emission layer is formed by dipping a substrate in a suspension, where electrodes and an insulation layer are arranged in the substrate, and the suspension is produced by dispersing Si-doped GaN powder in methanol. When production of the above electroluminescent element is completed, i.e., after methanol is completely evaporated, the Si-doped GaN powder is deposited so that particles constituting the powder are in contact with each other, and spaces between the deposited particles are not filled.

Further, the aforementioned document (2) discloses another electroluminescent element in which fluorescent particles are deposited in a dielectric layer having a high permittivity (e.g., a layer of BaTiO₃) so that a deposit (lower) portion in the dielectric layer behaves as a light emission layer, and the remaining (upper) portion of the dielectric layer behaves as an insulation layer. In this electroluminescent element, it is conjectured that a portion of fluorescent particles in the light emission layer are in contact with each other. In this case, spaces between the deposited fluorescent particles are filled with the dielectric material having the high permittivity. Since the dielectric material with which the spaces between the deposited fluorescent particles are filled is identical to the material constituting the insulation layer, it is considered that the efficiency in application of the voltage to each fluorescent particle is improved, and high-intensity light emission is realized.

As explained above, in most of the conventional AC-driven, dispersion type electroluminescent elements, completely or almost completely discrete dispersion of the fluorescent particles is realized in the binder in order to block current paths and apply a stable, strong electric field to each fluorescent particle. Although, in some cases, it is conjectured that a portion of fluorescent particles in the light emission layer are in contact with each other, the light emission layer in each of the conventional AC-driven, dispersion type electroluminescent elements is formed by simple deposition or a similar technique. Therefore, the filling factor of the fluorescent particles in the light emission layer is low and considered to be below about 50%.

However, when the filling factor of the fluorescent particles in the light emission layer is low, the ratio of the voltage applied to the fluorescent particles to the full voltage applied to each of the conventional AC-driven, dispersion type electroluminescent elements decreases. Therefore, the efficiency in voltage application to the fluorescent particles is low, and it is difficult to achieve light emission with high intensity. Thus, it is desirable that the density of fluorescent particles with which the light emission layer is filled is maximized within the range in which current paths can be blocked.

### SUMMARY OF THE INVENTION

The present invention has been developed in view of the above circumstances.

The first object of the present invention is to provide an AC-driven electroluminescent element having a structure of a dispersion type and a light emission layer which are filled with densely arranged fluorescent particles in such a manner that current paths is surely blocked.

The second object of the present invention is to provide a method for producing the above AC-driven electroluminescent element.

(I) In order to accomplish the above first object, the first aspect of the present invention is provided. According to the first aspect of the present invention, there is provided an AC-driven electroluminescent element which comprises: a pair of electrodes; a light emission layer being located between the pair of electrodes and containing a group of particles and a filler with which gaps between the particles are filled; and at least one insulation layer which is arranged on at least one side of the light emission layer. The group of particles is a first, second, third, or fourth group of particles, or a combination of two or more groups of the first, second, third, and fourth groups of particles, where each particle in the first group is made of a first fluorescent material, each particle in the second group is constituted by a first dielectric core made of a first dielectric material and a surface coating being made of a second fluorescent material and covering the first dielectric core; each particle in the third group is constituted by a fluorescent core made of a third fluorescent material and a surface coating being made of a second dielectric material and covering the fluorescent core; each particle in the fourth group is constituted by a second dielectric core made of a third dielectric material, a fluorescent layer formed on the second dielectric core and made of a fourth fluorescent material, and a surface coating being made of a fourth dielectric material and covering the fluorescent layer. The particles contained in the light emission layer are fused with each other or in mechanical or electrical contact with each other, and the ratio of the volume occupied by the particles contained in the light emission layer to the volume occupied by the filler is 1.0 or greater.

In the first and second aspects of the present invention, the expression “electrical contact” covers a situation in which the particles are arranged so close to each other that the particles are substantially in electrical contact with each other.

Preferably, the AC-driven electroluminescent element according to the first aspect of the present invention may also have one or any possible combination of the following additional features (i) to (iii).
(i) The filler may be a material having a low dielectric dissipation factor. It is particularly preferable that the dielectric dissipation factor is 0.01 or smaller.
(ii) The ratio may be 1.6 or greater.
(iii) Each of the first, second, third, and fourth fluorescent materials may contain luminescent centers which can be excited by collision of hot electrons.

(II) In order to accomplish the aforementioned first object, the second aspect of the present invention is provided. According to the second aspect of the present invention, there is provided an AC-driven electroluminescent element which comprises: a pair of electrodes; and a light emission layer being located between the pair of electrodes and containing a group of particles and a filler with which gaps between the particles are filled. The group of particles is a first or second group of particles, or a combination of the first and second groups of particles, where each particle in the first group is constituted by a fluorescent core made of a first fluorescent material and a surface coating being made of a first dielectric material and covering the fluorescent core, and each particle in the second group is constituted by a dielectric core made of a second dielectric material, a fluorescent layer formed on the dielectric core and made of a second fluorescent material, and a surface coating being made of a third dielectric material and covering the fluorescent layer. The particles contained in the light emission layer are fused with each other or in mechanical or electrical contact with each other, and the ratio of the volume occupied by the particles contained in the light emission layer to the volume occupied by the filler is 1.0 or greater.

In the AC-driven electroluminescent element according to the second aspect of the present invention, a fluorescent material may be exposed at a portion of the outer surface of each particle in a portion of the first and second groups of particles.

Preferably, the AC-driven electroluminescent element according to the second aspect of the present invention may also have one or any possible combination of the aforementioned additional features (i) to (iii).

(III) In order to accomplish the aforementioned second object, the third aspect of the present invention is provided. According to the third aspect of the present invention, there is provided a method for producing an AC-driven electroluminescent element including a pair of electrodes, a light emission layer located between the pair of electrodes, and at least one insulation layer which is arranged on at least one side of the light emission layer. The method comprises the steps of: (a) forming a layer of a material in which a group of particles are dispersed in a binder; and (b) compressing the layer formed in step (a) so as to form the light emission layer. The group of particles is a first, second, third, or fourth group of particles, or a combination of two or more groups of the first, second, third, and fourth groups of particles, where each particle in the first group is made of a first fluorescent material, each particle in the second group is constituted by a first dielectric core made of a first dielectric material and a surface coating being made of a second fluorescent material and covering the first dielectric core; each particle in the third group is constituted by a fluorescent core made of a third fluorescent material and a surface coating being made of a second dielectric material and covering the fluorescent core; each particle in the fourth group is constituted by a second dielectric core made of a third dielectric material, a fluorescent layer formed on the second dielectric core and made of a fourth fluorescent material, and a surface coating being made of a fourth dielectric material and covering the fluorescent layer.

Preferably, the method according to the third aspect of the present invention may also have one or any possible combination of the following additional features (iv) and (v).
(iv) The binder may be a material having a low dielectric dissipation factor.
(v) The method having the above feature (iv) may further comprise a step of impregnating the layer compressed in step (b) with a material having a low dielectric dissipation factor. The material with which the layer compressed in step (b) is impregnated may or may not be identical to the binder. It is preferable that the dielectric dissipation factor of each of the binder and the material with which the layer compressed in step (b) is impregnated is 0.01 or smaller.

(IV) In order to accomplish the aforementioned second object, the fourth aspect of the present invention is provided. According to the fourth aspect of the present invention, there is provided a method for producing an AC-driven electroluminescent element including a pair of electrodes and a light emission layer located between the pair of electrodes. The method comprises the steps of: (a) forming a layer of a material in which a group of particles are dispersed in a binder; and (b) compressing the layer formed in step (a) so as to form the light emission layer. The group of particles is a first or second group of particles, or a combination of the first and second groups of particles, where each particle in the first group is constituted by a fluorescent core made of a first fluorescent material and a surface coating being made of a first dielectric material and covering the fluorescent core, and each particle in the second group is constituted by a dielectric core made of a second dielectric material, a fluorescent layer formed on the dielectric core and made of a second fluorescent material, and a surface coating being made of a third dielectric material and covering the fluorescent layer.

In the method according to the fourth aspect of the present invention, a fluorescent material may be exposed at a portion of the outer surface of each particle in a portion of the first and second groups of particles.

Preferably, the method according to the fourth aspect of the present invention may also have one or any possible combination of the aforementioned additional features (iv) and (v).

(V) In order to accomplish the aforementioned second object, the fifth aspect of the present invention is provided. According to the fifth aspect of the present invention, there is provided a method for producing an AC-driven electroluminescent element including a pair of electrodes, a light emission layer located between the pair of electrodes, and at least one insulation layer which is arranged on at least one side of the light emission layer. The method comprises the steps of: (a) forming a layer of a material in which a group of particles are dispersed in a pyrolytic binder; (b) thermally decomposing the pyrolytic binder in the layer formed in step (a) and removing the pyrolytic binder from the layer formed in step (a); and (c) impregnating the layer from which the pyrolytic binder is removed in step (b), with a filler material, so as to form the light emission layer. The group of particles is a first, second, third, or fourth group of particles, or a combination of two or more groups of the first, second, third, and fourth groups of particles, where each particle in the first group is made of a first fluorescent material, each particle in the second group is constituted by a first dielectric core made of a first dielectric material and a surface coating being made of a second fluorescent material and covering the first dielectric core; each particle in the third group is constituted by a fluorescent core made of a third fluorescent material and a surface coating being made of a second dielectric material and covering the fluorescent core; each particle in the fourth group is constituted by a second dielectric core made of a third dielectric material, a fluorescent layer formed on the second dielectric core and made of a fourth fluorescent material, and a surface coating being made of a fourth dielectric material and covering the fluorescent layer.

Preferably, in the method according to the fifth aspect of the present invention, the filler material is a material having a low dielectric dissipation factor. It is particularly preferable that the dielectric dissipation factor is 0.01 or smaller.

(VI) In order to accomplish the aforementioned second object, the sixth aspect of the present invention is provided. According to the sixth aspect of the present invention, there is provided a method for producing an AC-driven electroluminescent element including a pair of electrodes and a light emission layer located between the pair of electrodes. The method comprises the steps of: (a) forming a layer of a material in which a group of particles are dispersed in a pyrolytic binder; (b) thermally decomposing the pyrolytic binder in the layer formed in step (a) and removing the pyrolytic binder from the layer formed in step (a); and (c) impregnating the layer from which the pyrolytic binder is removed in step (b), with a filler material, so as to form the light emission layer. The group of particles is a first or second group of particles, or a combination of the first and second groups of particles, where each particle in the first group is constituted by a fluorescent core made of a first fluorescent material and a surface coating being made of a first dielectric material and covering the fluorescent core, and each particle in the second group is constituted by a dielectric core made of a second dielectric material, a fluorescent layer formed on the dielectric core and made of a second fluorescent material, and a surface coating being made of a third dielectric material and covering the fluorescent layer.

In the method according to the sixth aspect of the present invention, each particle in a portion of the first and second groups of particles may be partially covered with a fluorescent material.

Preferably, in the method according to the sixth aspect of the present invention, the filler material is a material having a low dielectric dissipation factor. It is particularly preferable that the dielectric dissipation factor is 0.01 or smaller.

(VII) The advantages of the present invention are as follows.
(1) In the AC-driven electroluminescent elements according to the first and second aspects of the present invention, the particles contained in the light emission layer are so densely arranged in the light emission layer that the particles contained in the light emission layer are fused with each other or in mechanical or electrical contact with each other, and current paths is surely blocked by the provision of the at least one insulation layer and/or the dielectric surface coating. Therefore, it is possible to achieve high efficiency in voltage application to the fluorescent material and light emission with high intensity without causing problems such as occurrence of a short circuit in the electroluminescent element. In addition, since the gaps between the particles in the light emission layer are filled with a filler, problems such as discharge do not occur in the light emission layer.
(2) In the case where the filler with which the gaps between the particles are filled in the light emission layer is a material having a low dielectric dissipation factor, energy consumed in the filler can be suppressed. Therefore, it is possible to achieve high efficiency in voltage application to the fluorescent material and light emission with high intensity without causing problems of energy loss. In the case of the conventional AC-driven dispersion type electroluminescent elements in which fluorescent particles are discretely dispersed, in order to raise the voltage applied to each fluorescent particle, it is considered to be preferable to use as a filler a dielectric material having a high permittivity and a high dielectric dissipation factor. On the other hand, in the AC-driven electroluminescent elements according to the first and second aspects of present invention, the particles are so densely arranged in the light emission layer that the particles contained in the light emission layer are fused with each other or in mechanical or electrical contact with each other. Therefore, when the insulation layer has a high permittivity, the voltage applied to each particle in the light emission layer is basically determined by the permittivity of the insulation layer. Thus, for a filler, the use of a dielectric material having a low dielectric dissipation factor and suppressing energy loss is more advantageous than the use of a dielectric material having a high permittivity and a high dielectric dissipation factor.
(3) When a fluorescent material containing luminescent centers which can be excited by collision of hot electrons is used for the fluorescent portions of the light emission layer, the intensity of the emitted light can be further increased. This is because the use of the fluorescent material containing luminescent centers which can be excited by collision of hot electrons realizes a light emission mechanism similar to the conventional thin-film type electroluminescent elements, which emit light with higher intensity than the conventional dispersion type electroluminescent elements, and the total reflection is prevented by the shape effect of the fluorescent particles and light scattering in the entire light emission layer.
(4) When the methods according to the third to sixth aspects of the present invention are used, it is possible to produce the AC-driven electroluminescent elements according to the first and second aspects of the present invention, in which mechanical or electrical contact between or fusion of the particles in the light emission layer is surely realized, and the aforementioned advantages are exerted. In addition, when the methods according to the third to sixth aspects of the present invention are used, the entire electroluminescent elements can be produced without executing complex steps. Therefore, the manufacturing cost can be suppressed.

### DESCRIPTION OF THE DRAWINGS

FIG. 1 is a cross-sectional view of a structure of an AC-driven electroluminescent element according to a first embodiment of the present invention.

FIG. 2 is a cross-sectional view of a structure of an AC-driven electroluminescent element according to a second embodiment of the present invention.

FIG. 3 is a cross-sectional view of a structure of an AC-driven electroluminescent element according to a third embodiment of the present invention.

FIG. 4 is a cross-sectional view of a structure of an AC-driven electroluminescent element according to a fourth embodiment of the present invention.

FIG. 5 is a cross-sectional view of a structure of an AC-driven electroluminescent element according to a fifth embodiment of the present invention.

FIG. 6 is a cross-sectional view of a structure of an AC-driven electroluminescent element according to a sixth embodiment of the present invention.

FIG. 7 is a cross-sectional view of the basic structure of a conventional AC-driven dispersion type electroluminescent element.

FIG. 8 is a cross-sectional view of the basic structure of a conventional AC-driven thin-film type electroluminescent element.

### DESCRIPTION OF PREFERRED EMBODIMENTS

Embodiments of the present invention are explained in detail below with reference to drawings.

### First Embodiment

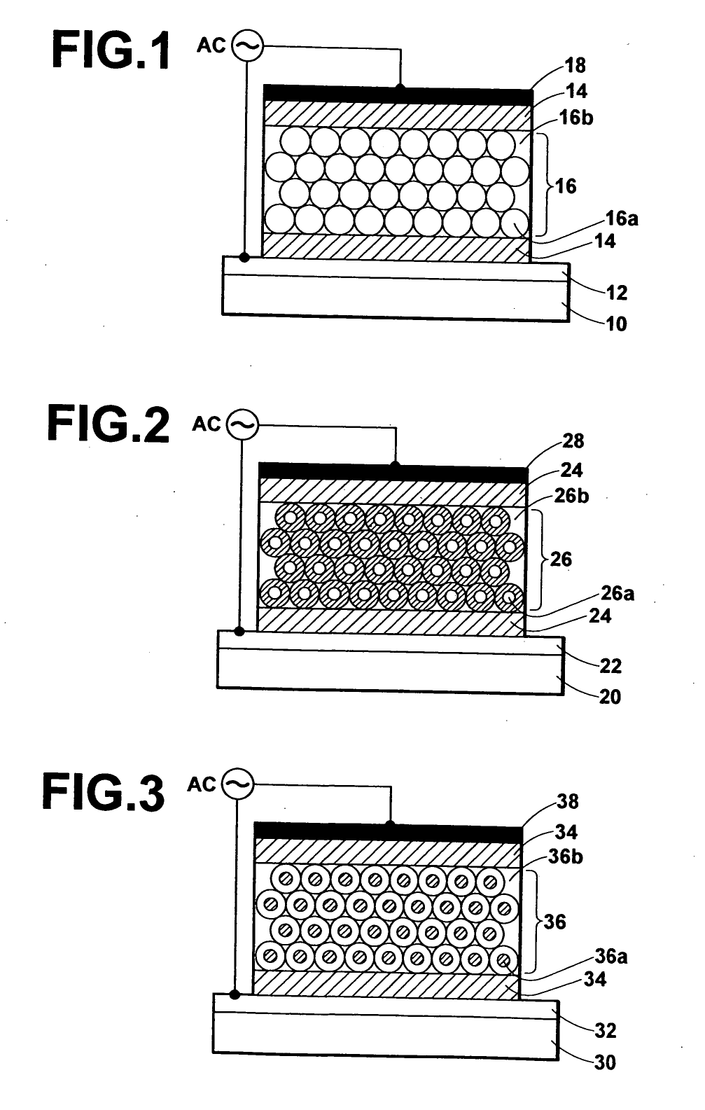

FIG. 1 is a cross-sectional view of the structure of the AC-driven electroluminescent element according to the first embodiment of the present invention. As illustrated in FIG. 1, a transparent electrode 12 and a first insulation layer 14 are formed on a transparent substrate 10, and a light emission layer 16 is formed on the first insulation layer 14. The light emission layer 16 is composed of fluorescent particles 16a and a filler 16b. Each of the fluorescent particles 16a is made of ZnS:Mn, and has a diameter of about 3 micrometers. The spaces between the fluorescent particles 16a are filled with the filler 16b. In FIG. 1 (also in FIGS. 2 through 4), the thickness of the light emission layer 16 and the sizes of the fluorescent particles 16a are exaggerated for clarification. In this example, the filler 16b is silicone oil, which is a material exhibiting a low dielectric dissipation factor of 0.0001 during application of an AC voltage of 50 Hz. The fluorescent particles 16a are densely arranged in the light emission layer 16 in such a manner that the fluorescent particles 16a are fused with each other or in mechanical or electrical contact with each other, and the ratio of the total volume of the fluorescent particles 16a to the total volume of the filler 16b is 1.0 or greater, and more preferably 1.6 or greater. In addition, a second insulation layer 14 and a metal electrode 18 are formed on the light emission layer 16. Further, one of the first and second insulation layers 14 can be dispensed with.

When an AC voltage is applied between the transparent electrode 12 and the metal electrode 18, electrons are injected into the fluorescent particles 16a from traps in the fluorescent particles 16a, and/or the interfaces between the light emission layer 16 and the first and second insulation layers 14, and/or other portions, and accelerated so that the injected electrons become hot electrons, which cause collisional excitation of Mn as luminescent centers in the fluorescent particles. Thus, light is emitted. The emitted light is outputted through the transparent electrode 12 and the transparent substrate 10.

### Second Embodiment

FIG. 2 is a cross-sectional view of the structure of the AC-driven electroluminescent element according to the second embodiment of the present invention. As illustrated in FIG. 2, a transparent electrode 22 and a first insulation layer 24 are formed on a transparent substrate 20, and a light emission layer 26 is formed on the first insulation layer 24. The light emission layer 26 is composed of particles 26a and a filler 26b. Each of the particles 26a is constituted by a fluorescent core made of ZnS:Mn (as a fluorescent material) and a dielectric surface coating of Y₂O₃ (as a dielectric material) covering the fluorescent core, and has a diameter of about 3 micrometers. The spaces between the particles 26a are filled with the filler 26b. In this example, the filler 26b is silicone oil. The particles 26a are densely arranged in the light emission layer 26 in such a manner that the particles 26a are fused with each other or in mechanical or electrical contact with each other, and the ratio of the total volume of the particles 26a to the total volume of the filler 26b is 1.0 or greater, and more preferably 1.6 or greater. Although the thickness of the dielectric surface coating is exaggerated in FIG. 2 for clarification, actually the ratio of the volume of the fluorescent material to the volume of the dielectric surface coating in each of the particles 26a is about 10:1. In addition, a second insulation layer 24 and a metal electrode 28 are formed on the light emission layer 26. Further, since current paths through the light emission layer 26 are blocked by the dielectric surface coatings of the particles 26a, one or both of the first and second insulation layers 24 can be dispensed with.

When an AC voltage is applied between the transparent electrode 22 and the metal electrode 28, electrons are injected into the fluorescent core in each of the particles 26a from traps in the fluorescent core, and/or the interface between the fluorescent core and the dielectric surface coating, and/or other portions, and accelerated so that the injected electrons become hot electrons, which cause collisional excitation of Mn as luminescent centers in the fluorescent core. Thus, light is emitted. The emitted light is outputted through the transparent electrode 22 and the transparent substrate 20.

### Third Embodiment

FIG. 3 is a cross-sectional view of the structure of the AC-driven electroluminescent element according to the third embodiment of the present invention. As illustrated in FIG. 3, a transparent electrode 32 and a first insulation layer 34 are formed on a transparent substrate 30, and a light emission layer 36 is formed on the first insulation layer 34. The light emission layer 36 is composed of particles 36a and a filler 36b. Each of the particles 36a is constituted by a dielectric core made of Y₂O₃ (as a dielectric material) and a fluorescent layer made of ZnS:Mn (as a fluorescent material) and formed over the dielectric core, and has a diameter of about 3 micrometers. The spaces between the particles 36a are filled with the filler 36b. In this example, the filler 36b is silicone oil. The particles 36a are densely arranged in the light emission layer 36 in such a manner that the particles 36a are fused with each other or in mechanical or electrical contact with each other, and the ratio of the total volume of the particles 36a to the total volume of the filler 36b is 1.0 or greater, and more preferably 1.6 or greater. In addition, a second insulation layer 34 and a metal electrode 38 are formed on the light emission layer 36. Further, one of the first and second insulation layers 34 can be dispensed with.

When an AC voltage is applied between the transparent electrode 32 and the metal electrode 38, electrons are injected into the fluorescent layer in each of the particles 36a from traps in the fluorescent layer, and/or the interface between the light emission layer 36 and the first and second insulation layers 34, and/or other portions, and accelerated so that the injected electrons become hot electrons, which cause collisional excitation of Mn as luminescent centers in the fluorescent layer. Thus, light is emitted. The emitted light is outputted through the transparent electrode 32 and the transparent substrate 30.

### Fourth Embodiment

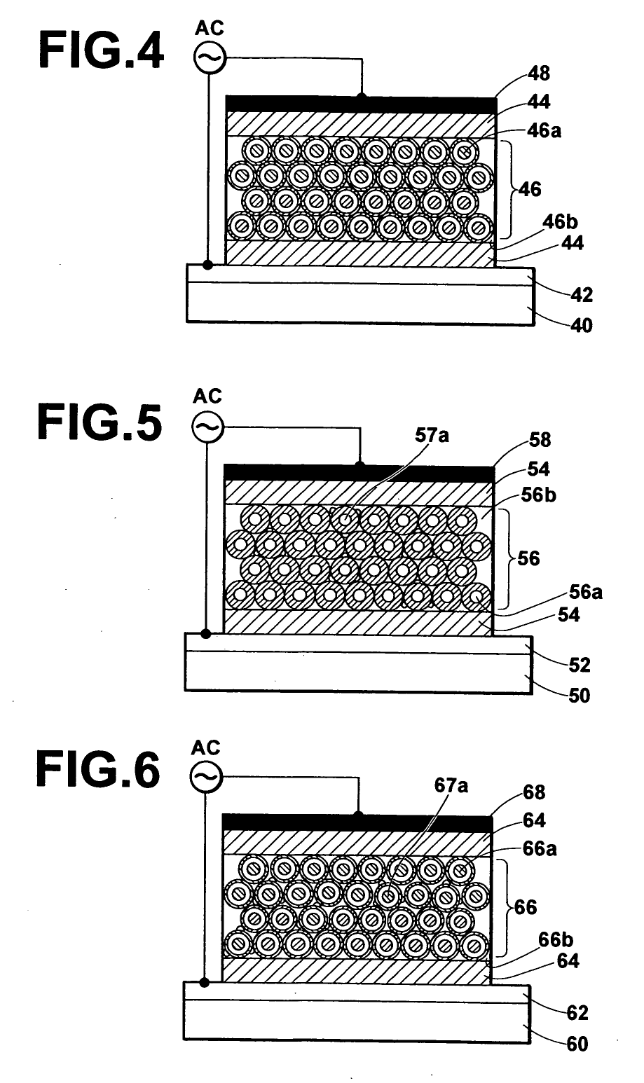

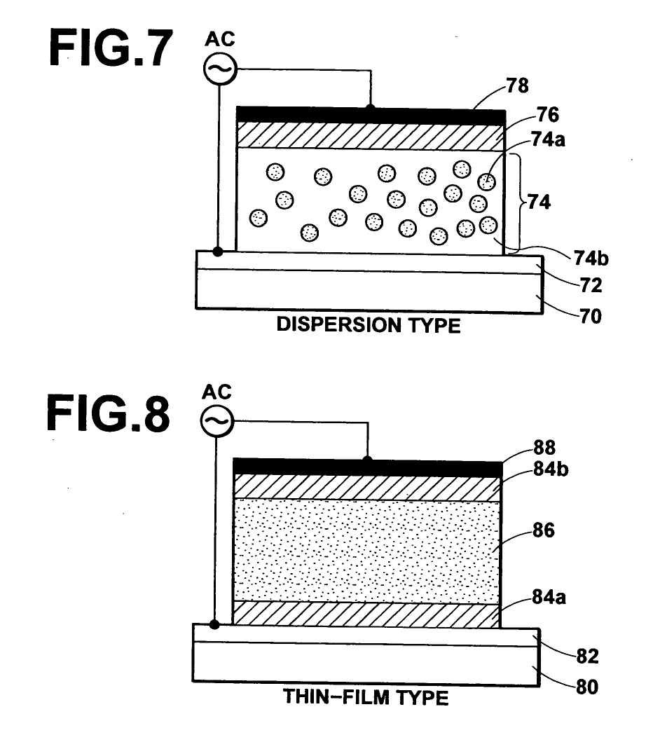

FIG. 4 is a cross-sectional view of the structure of the AC-driven electroluminescent element according to the fourth embodiment of the present invention. As illustrated in FIG. 4, a transparent electrode 42 and a first insulation layer 44 are formed on a transparent substrate 40, and a light emission layer 46 is formed on the first insulation layer 44. The light emission layer 46 is composed of particles 46a and a filler 46b. Each of the particles 46a is constituted by a dielectric core made of BaTiO₃ (as a dielectric material), a fluorescent layer made of ZnS:Mn (as a fluorescent material) and formed over the dielectric core, and a dielectric surface coating of Y₂O₃ (as a dielectric material) covering the fluorescent layer. Each of the particles 46a has a diameter of about 3 micrometers. Alternatively, the dielectric core and the dielectric surface coating may be made of an identical dielectric material. In order to efficiently apply the voltage to the light emission layer, it is preferable that the dielectric core is made of a material having a high permittivity. The spaces between the particles 46a are filled with the filler 46b. In this example, the filler 46b is silicone oil. The particles 46a are densely arranged in the light emission layer 46 in such a manner that the particles 46a are fused with each other or in mechanical or electrical contact with each other, and the ratio of the total volume of the particles 46a to the total volume of the filler 46b is 1.0 or greater, and more preferably 1.6 or greater. In is addition, a second insulation layer 44 and a metal electrode 48 are formed on the light emission layer 46. Further, since current paths through the light emission layer 46 are blocked by the dielectric surface coatings of the particles 46a, one or both of the first and second insulation layers 44 can be dispensed with.

When an AC voltage is applied between the transparent electrode 42 and the metal electrode 48, electrons are injected into the fluorescent layer in each of the particles 46a from traps in the fluorescent layer, and/or the interface between the dielectric surface coating and the fluorescent layer, and/or other portions, and accelerated so that the injected electrons become hot electrons, which cause collisional excitation of Mn as luminescent centers in the fluorescent layer. Thus, light is emitted. The emitted light is outputted through the transparent electrode 42 and the transparent substrate 40.

### Fifth Embodiment

FIG. 5 is a cross-sectional view of the structure of the AC-driven electroluminescent element according to the fifth embodiment of the present invention. The AC-driven electroluminescent element according to the fifth embodiment is basically similar to the second embodiment illustrated in FIG. 2. According to the fifth embodiment, the light emission layer 56 is composed of particles 56a and a filler 56b. Each of the particles 56a is constituted by a fluorescent core made of ZnS:Mn (as a fluorescent material) and a dielectric surface coating of Y₂O₃ (as a dielectric material) covering the fluorescent core, and has a diameter of about 3 micrometers. The spaces between the particles 56a are filled with the filler 56b. The fifth embodiment is different from the second embodiment in that a fluorescent material is exposed at a portion of the outer surface of each particle in a portion 57a of the particles 56a contained in the light emission layer 56. Specifically, the dielectric surface coatings of the portion 57a of the particles 56a contained in the light emission layer 56 may be partially covered with a layer of a fluorescent material as illustrated in FIG. 5. Alternatively, the dielectric surface coatings of the portion 57a of the particles 56a contained in the light emission layer 56 may be partially removed or lost so that the fluorescent material under the dielectric surface coatings are partially exposed. The number of the particles in the above portion 57a is sufficiently smaller than the total number of the particles 56a so that the insulation of the light emission layer 56 is not broken. For example, the number of the particles in the portion 57a is about 1% of the total number of the particles 56a.

### Sixth Embodiment

FIG. 6 is a cross-sectional view of the structure of the AC-driven electroluminescent element according to the sixth embodiment of the present invention. The AC-driven electroluminescent element according to the sixth embodiment is basically similar to the fourth embodiment illustrated in FIG. 4. According to the sixth embodiment, the light emission layer 66 is composed of particles 66a and a filler 66b. Each of the particles 66a is constituted by a core made of a dielectric material, a fluorescent layer formed over the dielectric core, and a dielectric surface coating covering the fluorescent layer. Each of the particles 66a has a diameter of about 3 micrometers. The spaces between the particles 66a are filled with the filler 66b. The sixth embodiment is different from the fourth embodiment in that a fluorescent material is exposed at a portion of the outer surface of each particle in a portion 67a of the particles 66a contained in the light emission layer 66. Specifically, the dielectric surface coatings of the portion 67a of the particles 66a contained in the light emission layer 66 may be partially covered with a layer of a fluorescent material as illustrated in FIG. 6. Alternatively, the dielectric surface coatings of the portion 67a of the particles 66a contained in the light emission layer 66 may be partially removed or lost so that the fluorescent material under the dielectric surface coatings are partially exposed. The number of the particles in the portion 67a is sufficiently smaller than the total number of the particles 66a so that the insulation of the light emission layer 66 is not broken. For example, the number of the particles in the portion 67a is about 1% of the total number of the particles 66a.

Variations

(1) The fluorescent materials used in the electroluminescent element in each embodiment may be any fluorescent material which can emit light having a desired color. For example, the fluorescent materials used in the conventional AC-driven dispersion type electroluminescent elements, such as ZnS:Cu, Cl, may be used. However, from the viewpoint of light emission with high intensity, it is preferable to use fluorescent materials containing luminescent centers which can be excited by collision of hot electrons and being used in the conventional thin-film type electroluminescent elements. Examples of such fluorescent materials are indicated in Table 1.

TABLE 1

| Color | Material |
|---|---|
| UV (Ultraviolet-emitting | ZnF₂:Gd |
| Fluorophore) | |
| B (Blue-emitting | BaAl₂S₄:Eu, CaS:Pb, SrS:Ce, |
| Fluorophore) | SrS:Cu, CaGa₂S₄:Ce |
| G (Green-emitting | (Zn, Mg)S:Mn, ZnS:Tb, F, |
| Fluorophore) | Ga₂O₃:Mn |
| R (Red-emitting Fluorophore) | (Zn, Mg)S:Mn, CaS:Eu, |
| | ZnS:Sm, F, Ga₂O₃:Cr |

(2) The dielectric cores and dielectric surface coatings in the first to fourth embodiments may be made of any dielectric materials. For example, it is possible to use Ta₂O₅, BaTa₂O₆, TiO₂, Sr(Zr, Ti)O₃, SrTiO₃, PbTiO₃, Al₂O₃, Si₃N₄, ZnS, ZrO₂, PbNbO₃, or Pb(Zr, Ti)O₃, as well as BaTiO₃ and Y₂O₃.

(3) The fillers in the light emission layers may be any materials which can prevent current flow and discharge through the gaps between the particles. For example, it is possible to use polyurethane resin, epoxy resin, thermoplastic norbornene-based resin, ultraviolet-curing resin, and the like, as well as silicone oil. In addition, when the sol-gel method, sintering of nano-particles, or the like is used, glass or ceramic materials can be used as the fillers. Alternatively, it is possible to use dielectric materials having high permittivity, or mixtures of one of the above materials and particles of a dielectric material having high permittivity. However, from the viewpoint of suppression of energy loss, it is preferable to use materials having a low dielectric dissipation factor such as silicone oil, and is particularly preferable to use materials having a dielectric dissipation factor of 0.01 or smaller. Further, any combinations of the above materials can be used as the fillers.

(4) The insulation layers may be made of, for example, Y₂O₃, Ta₂O₅, BaTa₂O₆, BaTiO₃, TiO₂, Sr(Zr, Ti)O₃, SrTiO₃, PbTiO₃, Al₂O₃, Si₃N₄, ZnS, ZrO₂, PbNbO₃, or Pb(Zr, Ti)O₃. In order to apply a stable, high voltage to the light emission layer, it is preferable that the insulation layers are made of materials which have high permittivity and are resistant to dielectric breakdown. The insulation layers may be formed by a thin-film formation technique such as vacuum evaporation. Alternatively, the insulation layers may be realized by a dispersion film-formed by dispersing the above materials for the insulation layers in a binder. The binder can be made of the materials mentioned before for the fillers.

(5) The transparent substrates can be made of non-alkali glass such as barium borosilicate glass or aluminosilicate glass. Alternatively, the transparent electrodes can be realized by a film or sheet of polyethylene terephthalate (PET), polyethylene naphthalate (PEN), acryl resin, styrene resin, nylon resin, or the like.

(6) Although the transparent electrodes are typically made of indium tin oxide (ITO), the transparent electrodes may be made of a material containing as a main component ZnO:Al, Zn₂In₂O₅, (Zn, Cd, Mg)O—(B, Al, Ga, In, Y)₂O₃—(Si, Ge, Sn, Pb, Ti, Zr)O₂, (Zn, Cd, Mg)O—(B, Al, Ba, In, Y)₂O₃—Si, Sn, Pb)O, MgO—In₂O₃, or the like. Further, the transparent electrodes may be made of a GaN-based material, a Sn02-based material, or the like.

(7) The metal electrodes may be an aluminum electrode or the like. Although, in each of the first to fourth embodiments, the AC-driven electroluminescent element has a transparent electrode on one side and a metal electrode on the other side, the electrodes may be arranged in other ways. For example, in order to improve the light output efficiency, it is possible to replace the metal electrode with a transparent electrode, and provide a white reflection layer.

(8) As explained before, in the light emission layers in the first to fourth embodiments, the four types of particles, (a) fluorescent particles, (b) fluorescent particles coated with a dielectric surface coating, (c) dielectric particles coated with a fluorescent surface coating, and (d) dielectric particles on each of which a fluorescent layer and a dielectric surface coating are used, respectively. That is, particles of an identical type are used in each embodiment. Alternatively, it is possible to use a mixture of a plurality of different types of particles in an AC-driven electroluminescent element. Further, even in the case where particles of a single type is used in an AC-driven electroluminescent element, particles made of materials having different compositions may be mixed in an AC-driven electroluminescent element. In the above cases, a fluorescent material may be exposed at a portion of the outer surface of each particle in a portion of the particles of the above types (b) and/or (d). In any of the above cases, when at least a portion of the particles are not covered with a dielectric surface coating, and blocking of current paths in the light emission layer is insufficient, it is necessary to arrange an insulation layer on at least one side of the light emission layer.

(9) Although the diameters of the particles used in the first to fourth embodiments are about 3 micrometers, the sizes of the particles are not limited to about 3 micrometers. For example, the diameters of the particles may be about 30 micrometers, or 10 nm (i.e., the particles may be nano-particles). In the latter case, it is possible to reduce the thickness of the light emission layer and the total thickness of the AC-driven electroluminescent element. In the case where the diameters of the particles are about 30 micrometers, the increase in the thickness of the light emission layer makes the application of a high voltage difficult. Therefore, it is preferable to use the particles in which a fluorescent layer is formed on a dielectric core, as in the third and fourth embodiments. On the other hand, in the case where nano-particles are used, in order to promote generation of hot electrons, it is preferable to use the particles the outermost layer of which is made of a fluorescent material, as in the first and third embodiments. Further, the particles used in each AC-driven electroluminescent element may have different sizes.

(10) Although only the minimum necessary layers are illustrated in the first to fourth embodiments, when necessary, it is possible to provide an additional layer such as a surface protection layer.

Production Method

Hereinbelow, preferable methods for producing the AC-driven electroluminescent element according to the present invention are explained.

As explained before, in the light emission layer in the AC-driven electroluminescent elements according to the present invention, the particles are densely arranged in the light emission layer in such a manner that the particles are fused with each other or in mechanical or electrical contact with each other. The light emission layer can be formed by application of a material in which the particles are dispersed, to the filler material per se or a solution in which the filler material is dissolved in a solvent, or other similar techniques. However, it is preferable to form the light emission layer by the methods which are explained below by way of example.

In the first method, particles constituting a light emission layer are dispersed in a solution in which a binder is dissolved in a solvent, and then the solution is applied to a layer which has already been formed and is to be located adjacent to the light emission layer (e.g., an insulation layer), by using a doctor blade or the like. The binder is a material which can prevent current flow and discharge through the gaps between the particles. For example, the binder is polyurethane resin or the like. After the application of the above solution, the solvent is evaporated. Thereafter, the light emission layer is compressed by using a compression system such as a calender roll or a hot press, so that the particles become fused with each other or come into mechanical or electrical contact with each other in the light emission layer. In order to fill gaps which can occur between the particles and the filler, it is possible to impregnate the light emission layer with silicone oil, or impregnate the light emission layer with ultraviolet-curing resin and cure the ultraviolet-curing resin.

In the second method, particles constituting a light emission layer are dispersed in a solution in which a pyrolytic binder is dissolved in a solvent, and then the solution is applied to a layer which has already been formed and is to be located adjacent to the light emission layer. Thereafter, the binder and the solvent are heated and removed, and the structure containing the particles is impregnated with a filler material so that the gaps between the particles are filled with the filler material. The filler material is a material which can prevent current flow and discharge through the gaps between the particles. Preferably, the filler material is a material having a low dielectric dissipation factor such as silicone oil. Alternatively, it is possible to impregnate the above structure containing the particles with ultraviolet-curing resin and cure the ultraviolet-curing resin.

The layers constituting the AC-driven electroluminescent elements other than the light emission layer may be formed by using any of the known techniques such as vacuum evaporation and sputtering. However, from the viewpoint of suppression of the manufacturing cost, it is preferable to use a simple technique such as application or screen printing for formation of the layers other than the light emission layer.

Other Matters

Although the embodiments of the present invention are explained as above, the above embodiments are only examples of the present invention. The present invention is not limited to the described embodiments, and all suitable modifications and equivalents are regarded as falling within the scope of the invention in the appended claims and their equivalents.

All of the contents of the Japanese patent application No. 2003-328355 are incorporated into this specification by reference.

1. An AC-driven electroluminescent element comprising:
a pair of electrodes;
a light emission layer being located between said pair of electrodes and containing a group of particles and a filler with which gaps between the group of particles are filled; and
at least one insulation layer which is arranged on at least one side of said light emission layer;
wherein said group of particles is one of,
a first group of particles made of a first fluorescent material,
a second group of particles each of which is constituted by a first dielectric core made of a first dielectric material and a surface coating being made of a second fluorescent material and covering the first dielectric core,
a third group of particles each of which is constituted by a fluorescent core made of a third fluorescent material and a surface coating being made of a second dielectric material and covering the fluorescent core,
a fourth group of particles each of which is constituted by a second dielectric core made of a third dielectric material, a fluorescent layer formed on the second dielectric core and made of a fourth fluorescent material, and a surface coating being made of a fourth dielectric material and covering the fluorescent layer, and
a combination of two or more groups of the first, second, third, and fourth groups of particles; and
said particles contained in said light emission layer are fused with each other or in mechanical or electrical contact with each other, and a ratio of a volume occupied by the particles contained in the light emission layer to a volume occupied by said filler is 1.0 or greater.

2. An AC-driven electroluminescent element according to claim 1, wherein said filler is a material having a low dielectric dissipation factor.

3. An AC-driven electroluminescent element according to claim 1, wherein said ratio is 1.6 or greater.

4. An AC-driven electroluminescent element according to claim 1, wherein each of said first, second, third, and fourth fluorescent materials contains luminescent centers which can be excited by collision of hot electrons.

5. An AC-driven electroluminescent element comprising:
a pair of electrodes; and
a light emission layer being located between said pair of electrodes and containing a group of particles and a filler with which gaps between the group of particles are filled;
wherein said group of particles is one of,
a first group of particles each of which is constituted by a fluorescent core made of a first fluorescent material and a surface coating being made of a first dielectric material and covering the fluorescent core,
a second group of particles each of which is constituted by a dielectric core made of a second dielectric material, a fluorescent layer formed on the dielectric core and made of a second fluorescent material, and a surface coating being made of a third dielectric material and covering the fluorescent layer, and
a combination of the first and second groups of particles; and
said particles contained in said light emission layer are fused with each other or in mechanical or electrical contact with each other, and a ratio of a volume occupied by the particles contained in the light emission layer to a volume occupied by said filler is 1.0 or greater.

6. An AC-driven electroluminescent element according to claim 5, wherein said filler is a material having a low dielectric dissipation factor.

7. An AC-driven electroluminescent element according to claim 5, wherein said ratio is 1.6 or greater.

8. An AC-driven electroluminescent element according to claim 5, wherein each of said first and second fluorescent materials contains luminescent centers which can be excited by collision of hot electrons.

9. An AC-driven electroluminescent element according to claim 5, wherein a fluorescent material is exposed at a portion of an outer surface of each particle in a portion of the first and second groups of particles.

10. An AC-driven electroluminescent element according to claim 9, wherein said filler is a material having a low dielectric dissipation factor.

11. An AC-driven electroluminescent element according to claim 9, wherein said ratio is 1.6 or greater.

12. An AC-driven electroluminescent element according to claim 9, wherein each of said first and second fluorescent materials contains luminescent centers which can be excited by collision of hot electrons.

13. A method for producing an AC-driven electroluminescent element including a pair of electrodes, a light emission layer located between said pair of electrodes, and at least one insulation layer which is arranged on at least one side of said light emission layer, said method comprising the steps of:
(a) forming a layer of a material in which a group of particles are dispersed in a binder; and
(b) compressing said layer formed in step (a) so as to form said light emission layer;
wherein said group of particles is one of,
a first group of particles made of a first fluorescent material,
a second group of particles each of which is constituted by a first dielectric core made of a first dielectric material and a surface coating being made of a second fluorescent material and covering the first dielectric core,
a third group of particles each of which is constituted by a fluorescent core made of a third fluorescent material and a surface coating being made of a second dielectric material and covering the fluorescent core,
a fourth group of particles each of which is constituted by a second dielectric core made of a third dielectric material, a fluorescent layer formed on the second dielectric core and made of a fourth fluorescent material, and a surface coating being made of
a fourth dielectric material and covering the fluorescent layer, and
a combination of two or more groups of the first, second, third, and fourth groups of particles.

14. A method according to claim 13, wherein said binder is a material having a low dielectric dissipation factor.

15. A method according to claim 14, further comprising a step of impregnating said layer compressed in step (b) with a material having a low dielectric dissipation factor.

16. A method for producing an AC-driven electroluminescent element including a pair of electrodes and a light emission layer located between said pair of electrodes, comprising the steps of:
(a) forming a layer of a material in which a group of particles are dispersed in a binder; and
(b) compressing said layer formed in step (a) so as to form said light emission layer;
wherein said group of particles is one of,
a first group of particles each of which is constituted by a fluorescent core made of a first fluorescent material and a surface coating being made of a first dielectric material and covering the fluorescent core,
a second group of particles each of which is constituted by a dielectric core made of a second dielectric material, a fluorescent layer formed on the dielectric core and made of a second fluorescent material, and a surface coating being made of a third dielectric material and covering the fluorescent layer, and
a combination of the first and second groups of particles.

17. A method according to claim 16, wherein said binder is a material having a low dielectric dissipation factor.

18. A method according to claim 17, further comprising a step of impregnating said layer compressed in step (b) with a material having a low dielectric dissipation factor.

19. A method according to claim 16, wherein a fluorescent material is exposed at a portion of an outer surface of each particle in a portion of the first and second groups of particles.

20. A method according to claim 19, wherein said binder is a material having a low dielectric dissipation factor.

21. A method according to claim 20, further comprising a step of impregnating said layer compressed in step (b) with a material having a low dielectric dissipation factor.

22. A method for producing an AC-driven electroluminescent element including a pair of electrodes, a light emission layer located between said pair of electrodes, and at least one insulation layer which is arranged on at least one side of said light emission layer, said method comprising the steps of:
(a) forming a layer of a material in which a group of particles are dispersed in a pyrolytic binder;
(b) thermally decomposing said pyrolytic binder in said layer formed in step (a) and removing the pyrolytic binder from the layer formed in step (a); and
(c) impregnating said layer from which said pyrolytic binder is removed in step (b), with a filler material, so as to form said light emission layer;
wherein said group of particles is one of,
a first group of particles made of a first fluorescent material,
a second group of particles each of which is constituted by a first dielectric core made of a first dielectric material and a surface coating being made of a second fluorescent material and covering the first dielectric core,
a third group of particles each of which is constituted by a fluorescent core made of a third fluorescent material and a surface coating being made of a second dielectric material and covering the fluorescent core,
a fourth group of particles each of which is constituted by a second dielectric core made of a third dielectric material, a fluorescent layer formed on the second dielectric core and made of a fourth fluorescent material, and a surface coating being made of a fourth dielectric material and covering the fluorescent layer, and
a combination of two or more groups of the first, second, third, and fourth groups of particles.

23. A method according to claim 22, wherein said filler material is a material having a low dielectric dissipation factor.

24. A method for producing an AC-driven electroluminescent element including a pair of electrodes and a light emission layer located between said pair of electrodes, comprising the steps of:
(a) forming a layer of a material in which a group of particles are dispersed in a pyrolytic binder;
(b) thermally decomposing said pyrolytic binder in said layer formed in step (a) and removing the pyrolytic binder from the layer formed in step (a); and
(c) impregnating said layer from which said pyrolytic binder is removed in step (b), with a filler material, so as to form said light emission layer;
wherein said group of particles is one of,
a first group of particles each of which is constituted by a fluorescent core made of a first fluorescent material and a surface coating being made of a first dielectric material and covering the fluorescent core,
a second group of particles each of which is constituted by a dielectric core made of a second dielectric material, a fluorescent layer formed on the dielectric core and made of a second fluorescent material, and a surface coating being made of a third dielectric material and covering the fluorescent layer, and
a combination of the first and second groups of particles.

25. A method according to claim 24, wherein said filler material is a material having a low dielectric dissipation factor.

26. A method according to claim 24, wherein a fluorescent material is exposed at a portion of an outer surface of each particle in a portion of the first and second groups of particles.

27. A method according to claim 26, wherein said filler material is a material having a low dielectric dissipation factor.
